(19) United States
(12) Patent Application Publication
(10) Pub. No.: US 2014/0083799 A1
(43) Pub. Date: Mar. 27, 2014

(54) LADDER LEVELLING AND STABILISING DEVICE

(71) Applicant: Steve EVANS, (US)

(72) Inventor: Steve Evans, Bideford (GB)

(21) Appl. No.: 13/261,781

(22) PCT Filed: May 21, 2012
(86) PCT No.: PCT/GB2012/051155

§ 371 Date: Nov. 18, 2013

(30) Foreign Application Priority Data
May 23, 2011 (GB) 1108663.4

(51) Int. Cl. E06C 7/44

(52) U.S. Cl. CPC E06C 7/44
USPC 182/202

(57) ABSTRACT

The device is used to level and stabilise a ladder 100 having mutually-spaced rungs 101, 103 extending between a pair of substantially parallel side rails 102. The device includes a pair of extensible hydraulic rams 1 secured to lower ends of respective side rails linked by a conduit establishing a fluid passageway between the rams. A fail-to-safe manually-operable valve is normally closed to hydraulically isolate the rams from each other. A backplate 10 is fixed to each side rail 102 to provide mutually-spaced upper and lower ram attachments 3 and 4. The upper ram attachment 3 includes a pivotal connection which attaches the ram to the backplate for angular movement in the plane of the ladder. The lower ram attachment 4 includes a pair of stays containing L-shaped slots arranged to hold the ram in an angular position relative to the backplate. The slots are also arranged to raise the stays when the rams are moved inwards to a stowed position.

### TECHNICAL FIELD OF THE INVENTION

This invention relates to a ladder levelling and stabilising device.

### BACKGROUND

Many people are employed to work at height, and increasing numbers of people are undertaking improvement and maintenance work in their own homes. The use of ladders, especially with unsupervised and inexperienced users, can be very dangerous and is the cause of many accidents.

A major contributory factor is often unstable or uneven floors or surfaces, e.g. stepped surfaces. Under a ladder, such surfaces can cause it to become unsteady or impossible to work with.

Steel and aluminium ladders are available in a large variety of sizes, with differences in widths, spacing between the rungs, distances between the ground and the first rung, side rails (stiles) ranging from rectangular to channel-section, and rung sections ranging from square to triangular. Typically the rungs and side rails are hollow.

Much time can be wasted attempting to prop up ladders using sandbags, wooden wedges and broken bricks, which are prone to sudden movement.

Many existing patent applications have been filed to address this problem. By way of example, U.S. Pat. No. 5,044,468 discloses a ladder levelling device which has a pair of extensible hydraulic rams which are secured in a parallel configuration to the lower ends of respective side rails. A closed fluid passageway is established between the hydraulic rams allowing the rams to be extended by different amounts. A valve arrangement is operable to close the passageway and isolate the rams from each other so that they are unable to move when a load is applied to the ladder. While such devices provide an effective solution to the problem of levelling the ladder without risk of sudden movement they provide little or no additional lateral stability.

Proposals which address the problem of increasing stability do not effectively address the problem of levelling the ladder on uneven ground. EP 0 172 284 A1 suggests providing a ladder with a pair of inclined stabilising legs secured to opposite side rails. The stabilising legs are secured to spaced brackets which are clamped to opposite side rails by threaded rods extending through hollow rungs of the ladder. The stabilising legs therefore act as props while the weight of the ladder is mostly borne by the side rails. On uneven ground the height of the stabilising legs can be adjusted by adjusting the pivot point along the upper bracket, but there is no provision for levelling the ladder itself on uneven ground, e.g. by providing the side rails with adjustable rams.

The present invention seeks to provide a new and inventive form of ladder levelling and stabilising device which addresses the shortcomings of known devices.

### SUMMARY OF THE INVENTION

The present invention proposes a ladder levelling and stabilising device for use with a ladder having a plurality of mutually-spaced rungs extending between a pair of side rails, said device comprising:
a pair of extensible hydraulic rams;
a pair of attachment means adapted to secure the respective rams to lower ends of respective side rails;
conduit means for establishing a fluid passageway between the hydraulic rams; and
valve means operable to close the passageway and isolate the rams from each other;
   characterised in that

each attachment means includes a backplate which is fixed alongside the respective side rail in use to provide mutually-spaced upper and lower ram attachments, the upper ram attachment including a pivotal connection which attaches the ram to the backplate for angular movement in the plane of the ladder and the lower ram attachment including a stay arranged to hold the ram in an angular position relative to the backplate.

The present invention thus provides both levelling and increased lateral stability in a straightforward and user-friendly way.

### BRIEF DESCRIPTION OF THE DRAWINGS

The following description and the accompanying drawings referred to therein are included by way of non-limiting example in order to illustrate how the invention may be put into practice. In the drawings:

FIG. 1 is a general view of a ladder provided with a levelling device for use on uneven ground;

FIG. 2 is a general view of a ladder levelling and stabilising device in accordance with the invention;

FIG. 3 is a similar view of the device when placed in condition for storage and transportation;

FIG. 4 is an exploded view of one of the levelling rams, including an inset detail;

FIG. 5 includes two partially-exploded views of the ram mounting assembly;

FIG. 6 is a further exploded view showing the components used to secure the ram mounting assemblies to the ladder; and

FIG. 7 is a sectional detail showing part of the upper mounting.

### DETAILED DESCRIPTION OF THE DRAWINGS

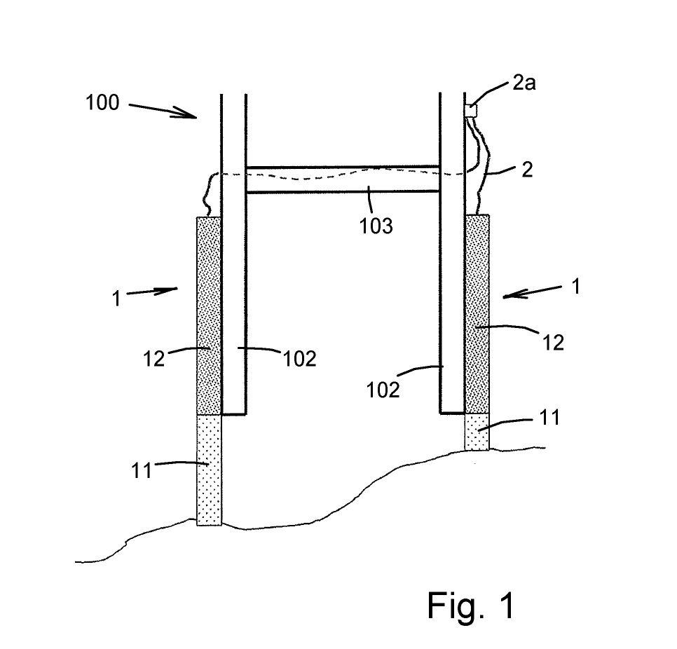

FIG. 1, illustrates the general principle of the invention which involves levelling of a ladder 100 using hydraulic rams. The ladder has mutually-spaced rungs extending between a pair of substantially parallel side rails 102, only the lowermost rung 103 being shown. Each side rail has an extensible hydraulic ram 1 at its lower end. The rams 1 are interconnected by a flexible hydraulic conduit 2 establishing a closed fluid passageway between the two rams. A valve 2a can be operated to hydraulically isolate the rams from each other. By adjusting the amount by which the inner sections 11 extend from the outer ram cylinders 12 before closing the valve 2a the ladder may be levelled to provide greater stability on sloping or uneven ground. However, such an arrangement provides no increase in stability over and above that resulting from the fact that the side rails are effectively changed in length to accommodate changes in ground level.

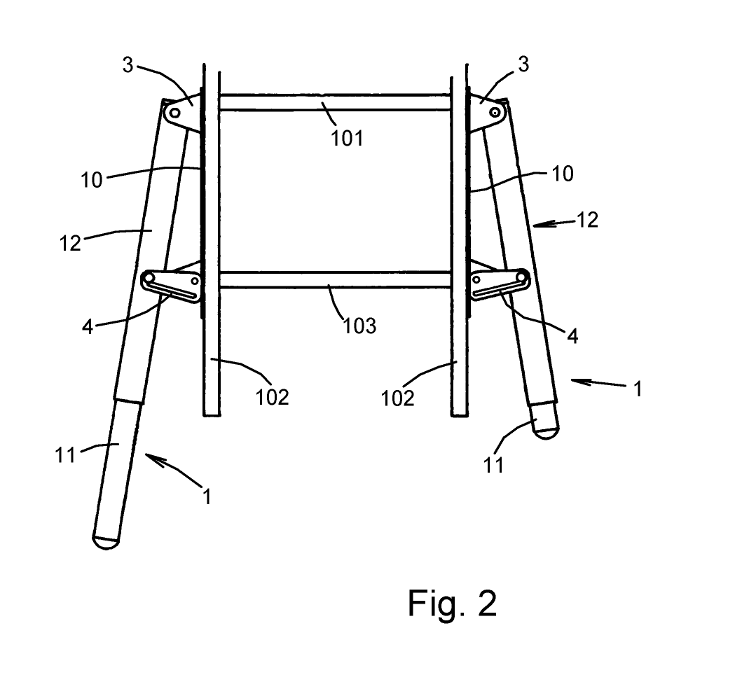

In accordance with the present invention, as shown in FIG. 2, each ram 1 is attached to the respective side rail 102 by means of a backplate 10 which is fixed to the outer face of the respective side rail at the level of the two lowermost rungs 101 and 103. The upper end of each ram cylinder 12 is pivotally connected to the backplate 10 by an upper ram attachment 3 which provides for angular movement of the ram in the plane of the ladder. A lower ram attachment 4 connects the ram cylinder 12 to the lower end of the respective plate 10 and forms a stay to hold the ram in an angular position relative to the backplate 10 and rail 102, as shown. The side rails can thus be supported off the ground by the extensible inner sections 11 of the rams 1. In addition to permitting levelling of the ladder on uneven ground as already described, the rams also provide increased spacing between the load-bearing supports in contact with the ground, thereby significantly increasing the inherent stability of the ladder.

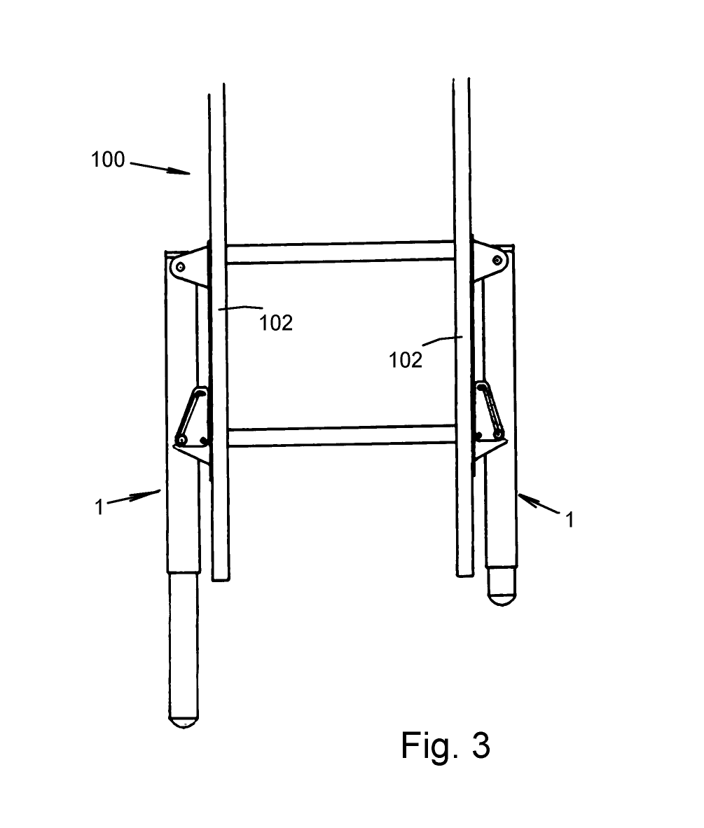

The configuration of the stays incorporated in the lower ram attachment 4, described below, also allows the rams 1 to be pivoted into a parallel configuration lying close to the side rails 102, as shown in FIG. 3. This closed configuration provides ease of transportation of the ladder on roof racks, trailers, vans or trucks for example, and also allows the ladder to be inserted easily into ladder stores without removal of the levelling and stabilising device.

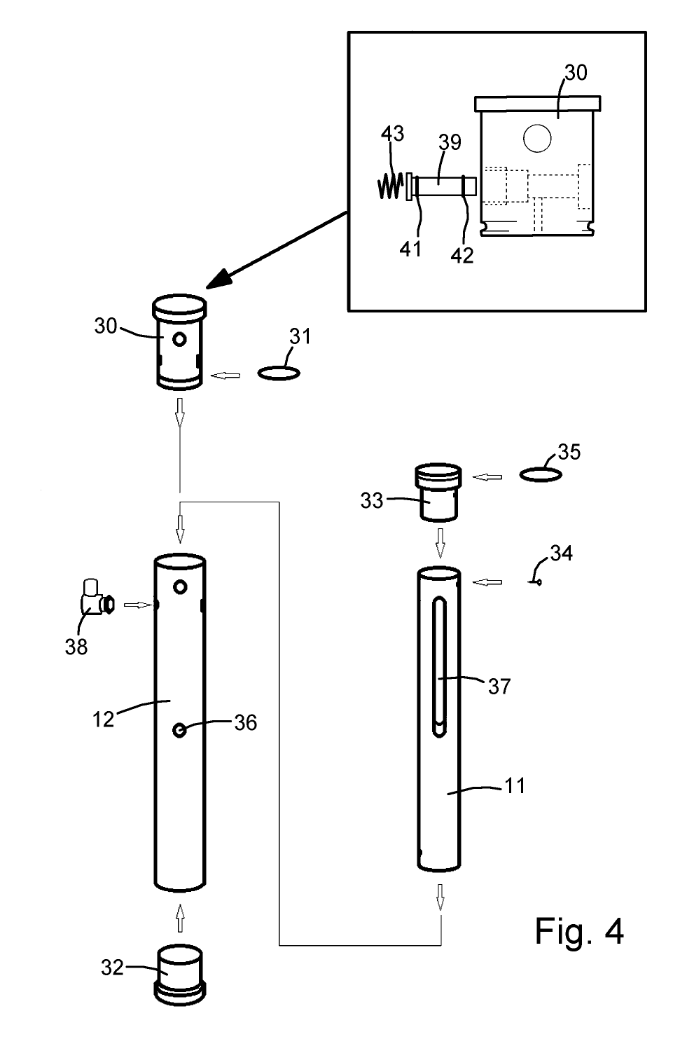

The structure of the ladder levelling and stabilising device will now be described referring firstly to FIG. 4 which is an exploded view of one of the hydraulic rams 1. Both rams are of similar construction. The outer ram cylinders 12 are provided with top caps 30 sealed by O-rings 31. The extensible inner sections 11 are slidably received within tubular guides 32 which are a push-fit in the lower ends of the cylinders 12. A piston head 33 is secured to the upper end of each inner section 11 by means of a screw 34, and the piston head carries an O-ring 35 to seal against the inner surface of the cylinder 12. A pin (see below) can be inserted through a hole 36 in cylinder 12 and through a slot 37 in the inner section 11 to limit its extent of travel. Each of the ram cylinders 12 is provided with an elbow fitting 38 providing a fluid connection between the internal fluid chamber above piston head 33 and the fluid conduit 2 shown in FIG. 1. The fittings 38 are engaged in a rotatable and sealing manner with the caps 30 so that the fittings can be rotated through 360 degrees into the most convenient position for the conduit 2, but in this case they are shown pointing upwards. One of the top caps 30, shown in the inset detail of FIG. 4, incorporates the valve 2a which comprises a valve element 39 carrying O-ring seals 41 and 42. The valve element is spring-loaded towards a closed position by a coil spring 43, retained by the respective end fitting 38. A recessed end of the valve element 39 is externally accessible from the opposite side of the cylinder so that the element may be manually depressed against the action of spring 43 allowing fluid to flow past the seal 41 and into the fitting 38, thereby opening the valve to allow fluid communication between the two rams. The valve “fails-to-safe” in that it is normally closed to prevent movement of the rams, and the arrangement of valve ensures that it is unlikely to be opened inadvertently. Indeed, increased loading of the rams during use of the ladder may increase the hydraulic pressure on the valve element causing the valve to be held even more firmly closed.

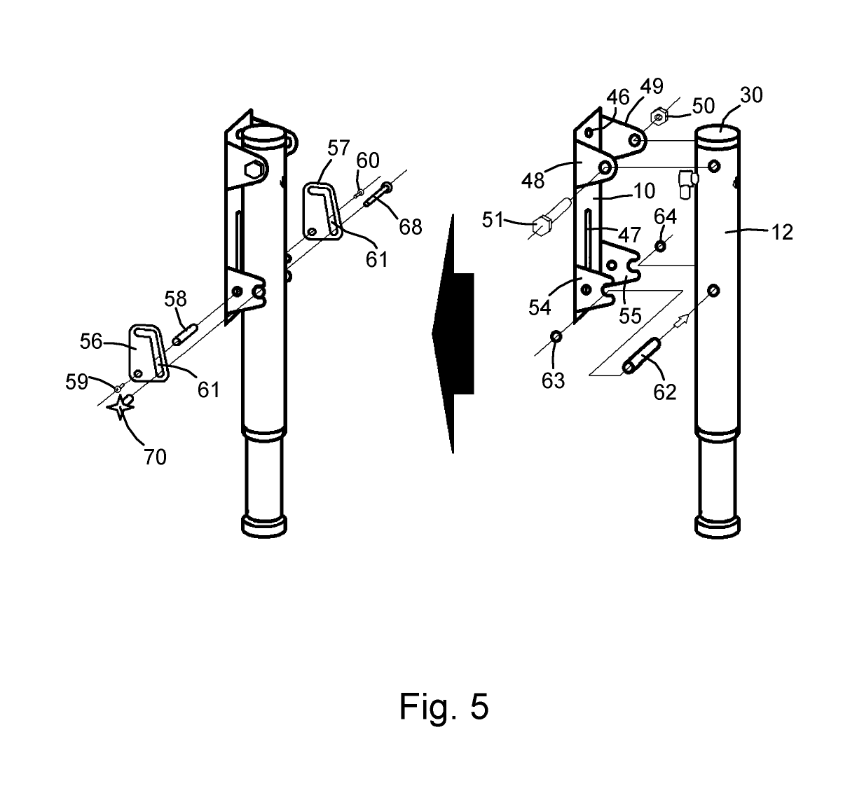

Referring now to FIG. 5, the mounting plate 10 has a top mounting hole 46 and a slot-shaped bottom mounting hole 47 allowing for differences in spacing between the two bottom rungs 101 and 103. The upper ram attachment 3 includes a pair of spaced flanges 48 and 49, projecting from opposite sides of the plate 10, between which the ram is secured by means of a nut 50 and bolt 51 forming a pivot pin for the ram. The bolt 51 passes through the cylinder 12 and top cap 30 holding the top cap in place. The lower ram attachment 4 includes a further pair of spaced flanges 54 and 55, projecting from opposite sides of the plate 10. A pair of stays formed by plates 56 and 57 are pivotally secured to the lower flanges 54 and 55 by means of a pivot pin 58 held by threadlock screws 59 and 60. Each of the stays contains a L-shaped slot 61 which extends along a bottom edge of the respective plate 56, 57 commencing below the pivot pin 58. The opposite end of each slot which is remote from the backplate 10 is upturned to extend along another edge of the respective plate. A tubular sleeve 62 is inserted through the ram, passing through the hole 36 and slot 37 (FIG. 4) and provided with end washers 63 and 64. A slide pin in the form of a coach bolt 68 is inserted through one of the stay plates 57, through washers 63, 64 and sleeve 62, and passing through the other stay plate 56 before receiving a threaded hand knob 70. Thus, by tightening the hand knob 70 it is possible to clamp the stay plates against both ends of the sleeve 62 to stop the ram from moving along the L-shaped slots 61.

When the rams 1 are stowed against the backplates 10 the stays 56 and 57 are in a raised position as shown in FIGS. 3 and 5 so that the stays do not project beyond the rams. However, as the rams pivot outwards towards an angular position the stay plates move downwards, assisted by gravity, as each bolt 68 travels along slots 61 away from the pivot pin 58. When the rams pivot to their maximum extent the plates may drop downwards under gravity (or pushed down by hand) so that the bolt 68 enters the upturned outer end of the slots, as in FIG. 2. The rams are thus unable to move inwardly again unless the plates 56 and 57 are flicked upwards. The hand knobs 70 may also be tightened for extra safety.

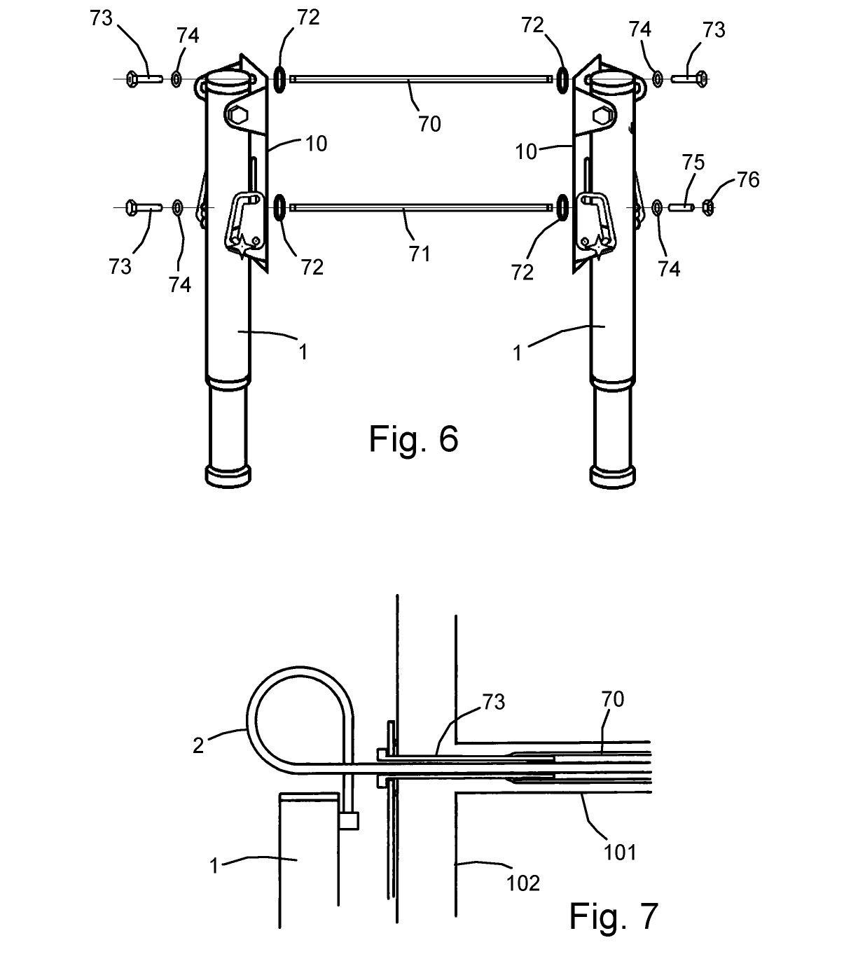

With reference to FIG. 6, the backplates 10 are secured to the side rails of the ladder by tubular tie rods 70 and 71 which are inserted through the hollow rungs. Annular rung spacers 72 of different sizes may be used to hold the tie rods approximately central within the rungs. Bolts 73 provided with spring washers 74 are inserted through the top and bottom backplate mounting holes 46 and 47 and screwed into the ends of the tie rods to clamp the backplates to the side rails of the ladder. The upper bolts 73 are both hollow so that, as shown in FIG. 7, the flexible hydraulic conduit 2 may be inserted through the bolts and passed through the upper tie rod 70 within the upper rung 101 to connect the two rams together. One of the bottom bolts can be replaced by a threaded stud 75 and nut 76 to allow greater flexibility with rung centre variations when using a spanner to tighten the bottom bolts, especially if the rung centre line conflicts with the pivot pin 58.

The levelling and stabilising device will fit most industrial, trade or domestic ladders with hollow rungs without any modification of the ladder, and is easy to fit or remove when required. The device is also easy and reliable to use. Any suitable hydraulic fluid may be used in the rams, including water.

Whilst the above description places emphasis on the areas which are believed to be new and addresses specific problems which have been identified, it is intended that the features disclosed herein may be used in any combination which is capable of providing a new and useful advance in the art.

1. A ladder levelling and stabilising device for use with a ladder (100) having a plurality of mutually-spaced rungs (101, 103) extending between a pair of side rails (102), said device comprising:
a pair of extensible hydraulic rams (1);
a pair of attachment means adapted to secure the respective rams to lower ends of respective side rails;
conduit means (2) for establishing a fluid passageway between the hydraulic rams; and
valve means (2a; 39-43) operable to close the passageway and isolate the rams from each other;
characterised in that
each attachment means includes a backplate (10) which is fixed alongside the respective side rail (102) in use to provide mutually-spaced upper and lower ram attachments (3, 4), the upper ram attachment including a pivotal connection (50, 51) which attaches the ram to the backplate for angular movement in the plane of the ladder and the lower ram attachment including a stay (56, 57) arranged to hold the ram in an angular position relative to the backplate.

2. A ladder levelling and stabilising device according to claim 1 in which the stay (56, 57) comprises an adjustable connection (61, 68) which permits the ram (1) to move angularly between a stowed position adjacent to the backplate and said angular position.

3. A ladder levelling and stabilising device according to claim 1 in which each stay comprises a pair of plates (56, 57) disposed on opposite sides of the respective ram.

4. A ladder levelling and stabilising device according to claim 3 in which the stays (56, 57) are pivotally connected (58-60) to the backplate.

5. A ladder levelling and stabilising device according to claim 4 in which the stays (56, 57) comprise a pair of slots (61) and the ram has a slide pin (68) which moves along the slots during angular movement of the ram.

6. A ladder levelling and stabilising device according to claim 5 in which the slide pin (68) is inserted through the ram (1).

7. A ladder levelling and stabilising device according to claim 5 in which the slide pin (68) carries a screw-threaded handwheel (70).

8. A ladder levelling and stabilising device according to claim 5 in which each slot (61) extends along a lower edge of respective stay plate commencing below the pivotal connection (58-60) with the backplate.

9. A ladder levelling and stabilising device according to claim 8 in which the end of each slot (61) remote from the backplate (10) has a upturned portion.

10. A ladder levelling and stabilising device according to claim 1 in which the valve means includes a valve element (39) which is spring loaded (43) to a normally-closed position.

11. A ladder levelling and stabilising device according to claim 10 in which the valve element (39) is arranged to be manually operated against said spring loading (43) to open the fluid conduit (2).
